(19) United States
(12) Patent Application Publication
(10) Pub. No.: US 2011/0123772 A1
(43) Pub. Date: May 26, 2011

(54) CORE SUBSTRATE AND METHOD OF MANUFACTURING CORE SUBSTRATE

(75) Inventors: Sang-Youp Lee, Seoul (KR); Joung-Gul Ryu, Seoul (KR); Dong-Sun Kim, Suwon-si (KR); Jae-Hoon Choi, Yongin-si (KR); In-Ho Seo, Suwon-si (KR); Joon-Sung Lee, Seoul (KR)

(73) Assignee: SAMSUNG ELECTRO MECHANICS CO., LTD.

(21) Appl. No.: 12/755,857

(22) Filed: Apr. 7, 2010

(30) Foreign Application Priority Data
Nov. 25, 2009 (KR) 10-2009-0114788

(51) Int. Cl. B32B 3/28; B44C 3/02

(52) U.S. Cl. 428/156; 156/219

(57) ABSTRACT

A core substrate and a method of manufacturing the core substrate are disclosed. In accordance with an embodiment of the present invention, the core substrate includes an adhesive resin layer having a mineral filler added therein, a metal sheet, which is patterned and embedded in the adhesive resin layer, and an insulation layer, which is stacked on both surfaces of the adhesive resin layer. Since a through-hole is formed to correspond to the number of via holes in accordance with a higher density of a printed circuit board, no conventional land is required to be formed, thereby reducing the defect of eccentricity.

### CROSS-REFERENCE TO RELATED APPLICATIONS

This application claims the benefit of Korean Patent Application No. 10-2009-0114788, filed with the Korean Intellectual Property Office on Nov. 25, 2009, the disclosure of which is incorporated herein by reference in its entirety.

### BACKGROUND

1. Technical Field

The present invention is related to a core substrate and a method of manufacture the core substrate.

2. Description of the Related Art

In step with the trends toward smaller, higher density and thinner electronic components, studies are underway to develop a thinner semiconductor package substrate with higher functionalities. Particularly, in order to implement a multi-chip package (MCP) technology, in which a plurality of semiconductor chips are stacked on one substrate, or a package on package (POP) technology, in which a plurality of substrates having chips embedded therein are stacked on one another, it is needed to develop a printed circuit board that has a thermal expansion behavior that is similar to that of a chip and has excellent warpage properties after the chip is embedded.

With the recent trend toward higher-performance chips, the increase in operating speed of the chip causes a heating problem. Consequently, finding a solution to this problem is desperately needed. In response to this demand, a highly heat-conductive metal plate, for example, a copper plate or an aluminum plate, is commonly inserted into a core of the printed circuit board to manufacture a core substrate. Since the metal plate has excellent thermal expansion properties and thermal conductive properties, the metal plate can inhibit the thermal expansion behavior of the substrate and perform the functions of heat dissipation.

In this kind of core substrate, a metal has to be inserted, and thus a process of removing a portion in which a hole is to be processed for interlayer connection or a process for using the metal as a land has to be performed. Particularly, a thin metal plate of the thickness of 35 μm or less is used to lower the thickness of the substrate, but it is very difficult to make a hole in a thin metal plate that has a surface area that is wide compared to the thickness. Moreover, forming a land may cause a defect of eccentricity.

Furthermore, in the case of a typical core substrate, prepreg is used, but the thermal conductivity of a metal to be used in the core may be deteriorated because of the lower thermal conductivity of woven glass fiber included in the prepreg.

### SUMMARY

The present invention provides a core substrate and a method of manufacturing the core substrate that can increase the heat dissipation efficiency.

An aspect of the present invention provides a core substrate that includes an adhesive resin layer having a mineral filler added therein, a metal sheet, which is patterned and embedded in the adhesive resin layer, and an insulation layer, which is stacked on both surfaces of the adhesive resin layer.

Another aspect of the present invention provides a method of manufacturing a core substrate that includes providing a metal film laminate, in which a first insulation layer, a first adhesive resin layer having a mineral filler added therein and a metal film are successively stacked on one another, patterning the metal film and stacking a second adhesive resin layer having a mineral filler added therein and a second insulation layer on an upper surface of the metal film.

The method can further include, after the stacking of the second adhesive resin layer and the second insulation layer, forming a through-hole for making connection between an upper end and a lower end of the core substrate.

The mineral filler can be made of a material including at least one selected from the group consisting of silica (SiO2), alumina (Al2O3), aluminum nitride (AlN), boron nitride (BN), magnesium oxide (MgO), silicon carbide (SiC) and silicon nitride (Si3N4).

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart illustrating a method of manufacturing a core substrate in accordance with an embodiment of the present invention.

FIGS. 2 to 6 show a method of manufacturing a core substrate in accordance with an embodiment of the present invention.

### DETAILED DESCRIPTION

As the invention allows for various changes and numerous embodiments, a particular embodiment will be illustrated in the drawings and described in detail in the written description. However, this is not intended to limit the present invention to a particular mode of practice, and it is to be appreciated that all changes, equivalents, and substitutes that do not depart from the spirit and technical scope of the present invention are encompassed in the present invention. In the description of the present invention, certain detailed descriptions of related art are omitted when it is deemed that they may unnecessarily obscure the essence of the invention.

While such terms as “first” and “second,” etc., may be used to describe various components, such components must not be limited to the above terms. The above terms are used only to distinguish one component from another.

The terms used in the present specification are merely used to describe a particular embodiment, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A core substrate and a method of manufacturing the core substrate according to a certain embodiment of the present invention will be described below in more detail with reference to the accompanying drawings. Those components that are the same or are in correspondence are rendered the same reference numeral regardless of the figure number, and redundant descriptions are omitted.

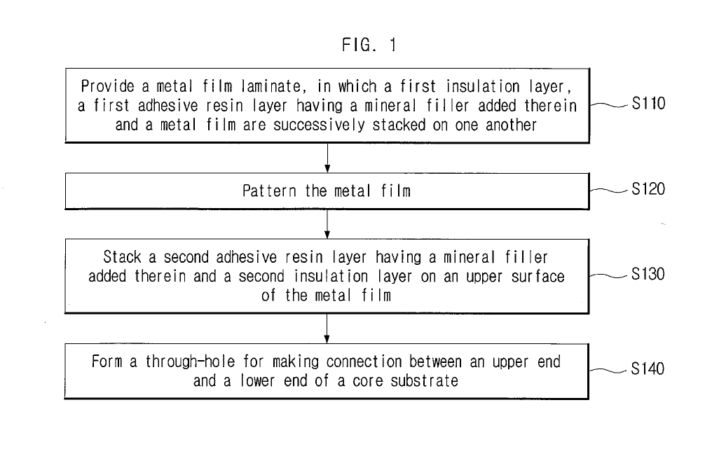

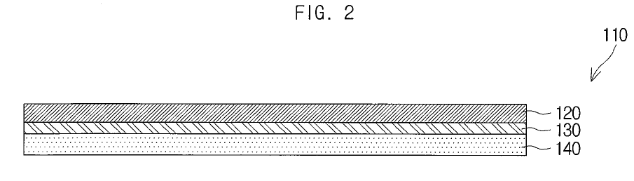

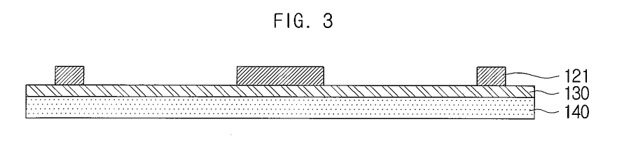

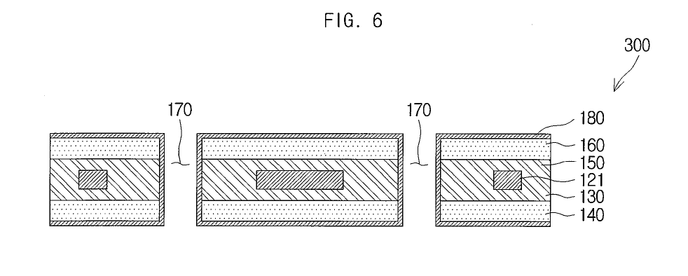

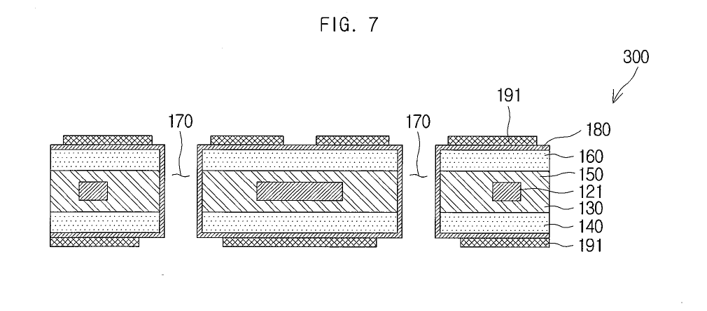

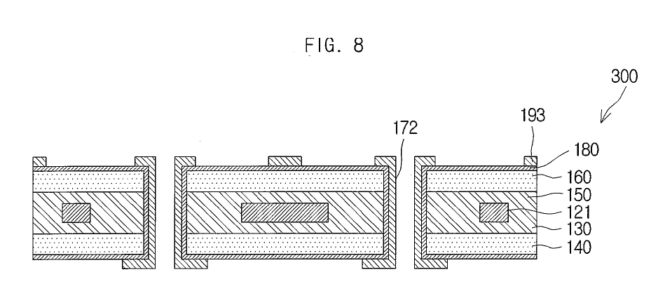

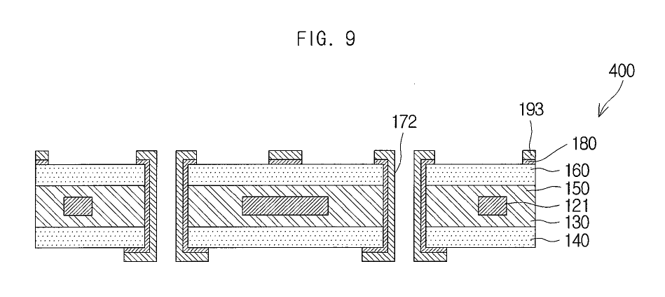

FIG. 1 is a flowchart illustrating a method of manufacturing a core substrate in accordance with an embodiment of the present invention, and FIGS. 2 to 6 show a method of manufacturing a core substrate in accordance with an embodiment of the present invention.

First, a metal film laminate 110, in which a first insulation layer 140, a first adhesive resin layer 130 having a mineral filler added therein and a metal film 120 are successively stacked on one another, is provided (S110). For this, the first adhesive resin layer 130 is first interposed between the first insulation layer 140, for example, polyimide, and the metal film 120, and then a roll-to-roll processing is performed by moving and compressing the first insulation layer, the first adhesive resin layer 130 and the metal film 120 in between rollers to form the metal film laminate 110. Here, a mineral filler made of a material including at least one of silica (SiO2), alumina (Al2O3), aluminum nitride (AlN), boron nitride (BN), magnesium oxide (MgO), silicon carbide (SiC) and silicon nitride (Si3N4) can be included in the first adhesive resin layer 130. Since a mineral filler, such as alumina or silica, and the metal film 120 have high thermal conductivity, the mineral filler and the metal film 120 can quickly release the heat generated by a chip embedded in a printed circuit board. Illustrated in FIG. 2 is the metal film laminate 110 described above.

Next, the metal film 120 is patterned (S120). In one example, an upper surface of the metal film 120 can be patterned by using a photolithography process. By patterning the metal film 120, a metal sheet 121 can be formed on top of the first insulation layer 140.

Next, a second adhesive resin layer 150 having a mineral filler added therein and a second insulation layer 160 are stacked on an upper surface of the metal sheet 121, which is formed by patterning the metal film 120 (S130).

By successively stacking the second adhesive resin layer 150 having a mineral filler added therein and the second insulation layer 160 on the upper surface of the metal sheet 121, the second adhesive resin layer 150 and the second insulation layer 160 can be laminated.

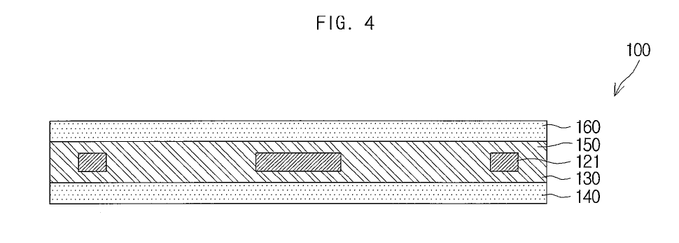

Illustrated in FIG. 4 is a core substrate 100 that is formed through the above processes and includes the adhesive resin layers 130 and 150 having a mineral filler added therein, the metal sheet 121, which is patterned and embedded in the adhesive resin layers 130 and 150, and the insulation layers 140 and 160, which are stacked on either surface of the adhesive resin layers 130 and 150. Since the core substrate 100 has a mineral filler, such as alumina or silica having high thermal conductivity, and the metal film 120 interposed therein, the heat transferred to a printed circuit board using the core substrate 100 of the present embodiment can be released quickly.

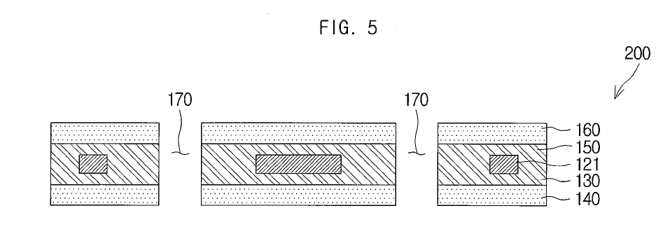

Next, a through-hole 170 can be formed by using a drill such as CNC or YAG/CO2 in order to make a connection between the upper and lower ends of the core substrate 100 (S140). After forming the through-hole 170, a desmearing process can be performed in order to remove a smear. Illustrated in FIG. 5 is a core substrate 200, through which the through-hole 170 is formed. Since the through-hole 170 is formed to correspond to the number of via holes in accordance with a higher density of the printed circuit board, no conventional land is required to be formed, thereby reducing the defect of eccentricity.

Next, sputtering or E-beam evaporation is performed on the surface of the insulation layers 140 and 160 and an inner wall of the through-hole 170, and a seed layer 180 is formed by using an electroless chemical copper method.

Next, a core circuit 193 can be formed on the insulation layers 140 and 160.

In the forming of the core circuit 193, as illustrated in FIG. 7, a plating resist 191 is first stacked on the surface of the seed layer 180 through a photolithography process. After stacking the plating resist 191 on the seed layer 180, excluding the area where the core circuit 193 and a via 172 are to be formed, a metal, such as copper, can be plated to form the core circuit 193. Then, as illustrated in FIG. 8, the plating resist 191 is removed, and then the seed layer exposed through flash etching is etched to form a core substrate 40 illustrated in FIG. 9.

In one example, if a 2-layered printed circuit board is to be manufactured, a pad that forms electrical connection to a semiconductor chip can be formed on the core substrate 400 described above, and then a solder resist can be coated so that the pad can be opened. In another example, if a 4-layered printed circuit board is to be manufactured by using the core substrate 300 described above, an insulation layer can be additionally stacked on the insulation layers 140 and 160 on which a circuit is formed in such a way that the core circuit 193 is covered to form an outer layer circuit, and then a solder resist can be stacked after forming a via.

In an embodiment of the present invention, the efficiency of heat dissipation of a printed circuit board can be enhanced by including a mineral filler having higher thermal conductivity.

Furthermore, since the through-hole according to an embodiment of the present invention is formed to correspond to the number of via holes in accordance with the higher density of the printed circuit board, no land needs to be formed in the conventional core substrate, thereby reducing the defect of eccentricity.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

As such, many embodiments other than that set forth above can be found in the appended claims.

What is claimed is:

1. A core substrate comprising:
an adhesive resin layer having a mineral filler added therein;
a metal sheet patterned and embedded in the adhesive resin layer; and
an insulation layer stacked on both surfaces of the adhesive resin layer.

2. The core substrate of claim 1, wherein the mineral filler comprises alumina or silica.

3. A method of manufacturing a core substrate, the method comprising:
providing a metal film laminate having a first insulation layer, a first adhesive resin layer and a metal film successively stacked thereon, the first adhesive resin layer having a mineral filler added therein;
patterning the metal film; and
stacking a second adhesive resin layer and a second insulation layer on an upper surface of the metal film, the second adhesive resin layer having a mineral filler added therein.

4. The method of claim 3, wherein the mineral filler is made of a material comprising at least one selected from the group consisting of silica (SiO2), alumina (Al2O3), aluminum nitride (AlN), boron nitride (BN), magnesium oxide (MgO), silicon carbide (SiC) and silicon nitride (Si3N4).

5. The method of claim 3, further comprising, after the stacking of the second adhesive resin layer and the second insulation layer, forming a through-hole for making connection between an upper end and a lower end of the core substrate.
